(19) United States
(12) Patent Application Publication
(10) Pub. No.: US 2009/0327484 A1
(43) Pub. Date: Dec. 31, 2009

(54) SYSTEM AND METHOD FOR ESTABLISHING PERSONAL SOCIAL NETWORK, TRUSTY NETWORK AND SOCIAL NETWORKING SYSTEM

(75) Inventors: YUN YEN CHEN, KAOHSIUNG CITY (TW); FANG JUNG HSU, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, HSINCHU (TW)

(21) Appl. No.: 12/346,009

(22) Filed: Dec. 30, 2008

(30) Foreign Application Priority Data
Jun. 27, 2008 (TW) 097124059

(51) Int. Cl. G06F 15/173

(52) U.S. Cl. 709/224

(57) ABSTRACT

The present invention provides a communication method of a community system, comprising the steps of: receiving a message from a member of a first environment by an apparatus; according to a community descriptive element of the message, examining whether the member of the first environment belongs to a first personal social network corresponding to the message; and if affirmative, providing a service according to the acquirement of the message.

### BACKGROUND OF THE INVENTION

1. Field of the Invention

The present invention relates to a social networking communication method, and more particularly to a social networking communication method for establishing personal social network, a trusty network, and a community with community trust mechanism.

2. Description of the Related Art

Use of communication services provided by social networking technology is an important trend for the future. A social networking service with Web 2.0 focuses on sharing daily life experiences, expressing opinions or introducing something new. For the purpose of security and privacy issues, many social networking sites have limitations to manage risks. However, a sharing freedom between the community members is restricted by such limitations. A key point of the limitations lies in how to address user privacy and security issues while obtaining sensitive user information in a proper way. The gathering of sensitive user information must be done with an eye toward the protection of user privacy and on the reliability of the trust degree of the objects with which a user communicates. Unfortunately, current service systems applying social network services lack privacy and the induced methods for the trust degree of the objects. Therefore, users are not protected when sensitive information is required for someone else.

The methods that most social networking sites adopt are to establish a personal address book and select a community by a user as a specified identity. However, if users have privacy and security concerns for providing sensitive information, they may be able to visit some websites without revealing their true identity. Although such step may avoid privacy and security problems, the user then cannot share the information freely in different fields due to the lack of interactive communication with other users.

U.S. Patent Publication No. 20070150603 discloses a method to a social network utilizing cross-domain infrastructures. The method provides redirection of information of a server for cross-domain social networking, and the method is designed to have a guide mode combining content in different fields and showing in a user display in a personal manner.

According to the social networking technology mentioned above, it is desirable to have a system and a method for handling the privacy and security issues, so that the communication service can have the high expandability and freedom for sharing the information in cross-domain use.

### SUMMARY OF THE INVENTION

The present invention provides a method for establishing a personal social network, comprising the steps of: providing a plurality of core community descriptive elements; extracting a designated trusty network from a trusty network according to the core community descriptive elements; removing a member in the designated trusty network whose trust degree is lower than a trust threshold value; and removing a member without connection in the designated trusty network according to the core community descriptive elements.

The present invention provides a method for establishing a trusty network, comprising the steps of: setting a group related term; establishing a community network according to the group related term; and setting a trust degree between a group of the community network and a member of the group.

The present invention provides a communication method of a community system, comprising the steps of: receiving a message from a member of a first environment by an apparatus; according to a community descriptive element of the message, examining whether the member of the first environment belongs to a first personal social network corresponding to the message; and if affirmative, providing a service according to the acquirement of the message.

The present invention discloses a community networking system, which comprises a personal apparatus and a server. The personal apparatus is connected to the Internet, and comprises a message-receiving module for receiving a message from a member of a first environment, an examining module for examining whether the member of the first environment belongs to a first personal social network according to a community descriptive element of the message, and a service-providing module for providing a service according to the acquirement of the message if the member of the first environment belongs to the first personal social network. The server comprises a message-receiving module for receiving the message from the apparatus and obtaining a core community descriptive element from the message, an obtaining module for obtaining an allowance corresponding list corresponding to the core community descriptive element from a storage apparatus, and an examining module for examining whether the apparatus and/or members belonging to the apparatus are in the allowance corresponding list.

### BRIEF DESCRIPTION OF THE DRAWINGS

The invention will be described according to the appended drawings in which:

FIG. 1A is a block diagram of a social networking system according to one embodiment of the present invention;

FIG. 1B is a block diagram of the structure of the social networking system according to one embodiment of the present invention;

FIG. 2 is a block diagram of an integrated communication data structure according to one embodiment of the present invention;

FIG. 3 is a block diagram of a communication module according to one embodiment of the present invention;

FIG. 4 is a flow diagram of a communication data management according to one embodiment of the present invention;

FIG. 5 is a flow diagram for communication according to one embodiment of the present invention;

FIG. 6 is a flow diagram of a physical communication module according to one embodiment of the present invention;

FIG. 7 is a flow diagram of a virtual communication module communication according to one embodiment of the present invention;

FIG. 8 is a flow diagram of the process for establishing a trusty network according to one embodiment of the present invention;

FIG. 9 is a block diagram of a semantic database and a social element table according to one embodiment of the present invention;

FIG. 10 is an illustration of the connection of the community according to one embodiment of the present invention;

FIG. 11 is an illustration of trust degrees between the connections of the personal social network according to one embodiment of the present invention;

FIG. 12 is a block diagram of establishing a personal social network according to one embodiment of the present invention;

FIG. 13 is a block diagram of establishing a core member list and an allowance corresponding list according to one embodiment of the present invention;

FIGS. 14-16 show flow diagrams of removing contact members according to one embodiment of the present invention; and

FIG. 17 is a block diagram of the structure of a community networking system according to one embodiment of the present invention.

### PREFERRED EMBODIMENT OF THE PRESENT INVENTION

The present invention discloses a system according to a personal social network, which is based on a personal community and uses an integrated personal communication handling mechanism to establish a representative community trust mechanism. The trust mechanism is a security mechanism of community activities requiring highly personal private information. The trust mechanism is based on building and protecting the community core information with privacy on personal information apparatuses, and the information of activities with less privacy concern is built in the server. In this way, the most personal private data is protected when users utilize an information service via the server, and a whole community system achieves an extreme trust connection with the security design of the operation between the apparatuses and the server.

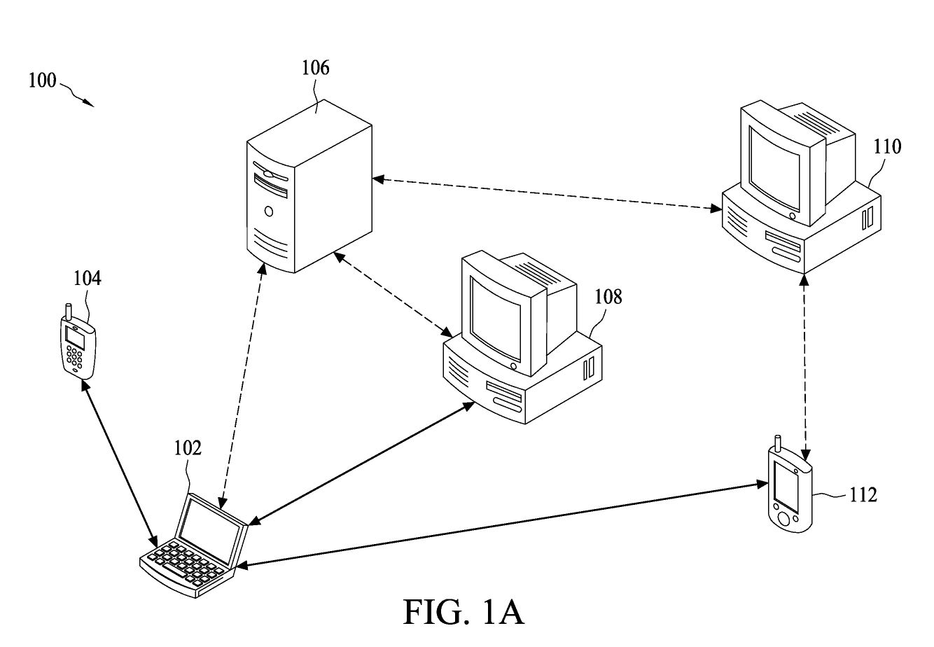

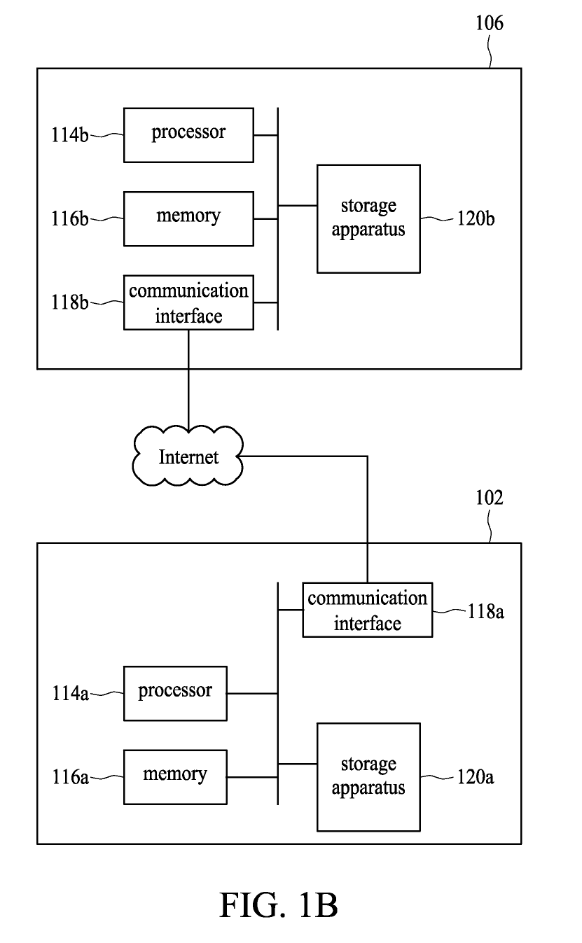

Referring to FIG. 1A, an embodiment of the present invention comprises an apparatus 102, connected to the Internet, and a server 106 for receiving and sending data. The apparatus 102 comprises a physical communication database and a virtual communication database, and users can access both directly. The physical communication database and the virtual communication database have user data of physical communication members and user data of virtual communication members, respectively. When a user wants to communicate with a physical apparatus 104, he or she can use the communication member data of the physical communication database in the apparatus 102 to communicate with the physical apparatus 104. The physical apparatus 104 herein is possessed by community members in the real world with which a user of the apparatus 102 is familiar. The virtual apparatus, in contrast, is possessed by community members in the virtual world. The apparatus 102 also comprises a trust mechanism to ensure secure communication, and a secure communicating connection is enabled with the apparatus 102. In addition to communicating directly, the apparatus 102 uses communication data in the server 106 to communicate with other community members. The server 106 also comprises a community trust mechanism established based on a personal community, whereby communication is more secure. The apparatus 102 and the server 106 both have personal social communication data established by users or systems, wherein the apparatus 102 further comprises personal social communication data with more privacy. Personal social communication data is protected by well-known information protection software and management application software. The server 106 comprises a core member chart, uploaded by community members, and a corresponding allowance list so that a communication range is securely expanded. The upload data by community members is also protected by the information protection software and the management application software. The trust mechanism is for controlling the interaction between community members. The purpose of the trust mechanism is to achieve the control of the communication behavior and data interchange on the condition of relevance and trust between community members. Community members who match the trust mechanism constitute the personal social network. The connection of the community information trusted by the whole is achieved by the control of the trust mechanism, and thus ensures the personal private information security and solves the problem of private security.

Referring to FIG. 1B, the apparatus 102 comprises a processor 114a, a memory 116a, a communication interface 118a and a storage apparatus 120a, wherein the memory 116a connected to a processor 114a comprises program instructions executed by the processor 114a to implement the method of the present invention. The storage apparatus 120a is used for storing files or data in the database, and the communication interface 118a is provided to the apparatus 102 for communication. A server 106 comprises a processor 114b, a memory 116b, a communication interface 118b and a storage apparatus 120b, wherein the memory 116b connected to a processor 114b comprises program instructions executed by the processor 114b to implement the method of the present invention. The storage apparatus 120b is used for storing files or data in the database, and the communication interface 118b is provided to the server 106 for communication. The interaction message transferred between the apparatus 102 and the server 106 can be sent based on the data interchange format and the Internet network protocols, such as TCP/IP (Transmission Control Protocol/Internet Protocol), HTTP (Hypertext Transfer Protocol), HTML (HyperText Markup Language), SOAP (Simple Object Access Protocol) and XML (Extensible Markup Language), and the exchange message can be encrypted or non-encrypted. The operation of the apparatus 102 using the server 106 for achieving indirect communication comprises searching the communication data of the apparatus 108 via the communication database of the server 106, and then communicating with the apparatus 108 based on the communication data, or, alternatively, comprises proceeding to communicate after the search for the communication data of the apparatus 112 in the communication database of the apparatus 110 electrically connected to the server 106.

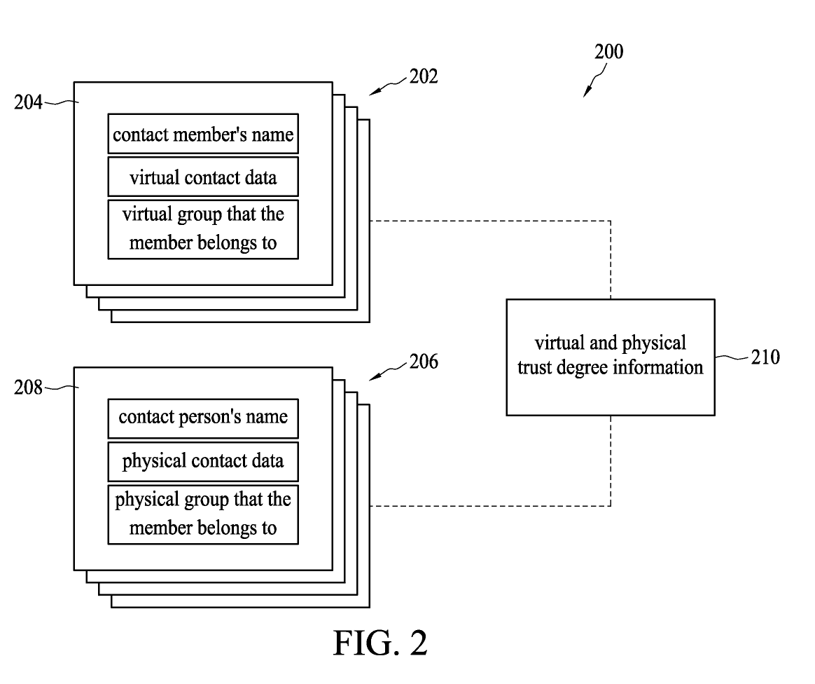

Referring to FIG. 2, a communication database 200 in the apparatus is an integrated communication database, which comprises a virtual communication database 202 and a physical communication database 206, both of which can be stored in an apparatus or a storage medium (i.e., a flash memory or a hard disk) connected to the apparatus.

The virtual communication database 202 comprises communication data 204 of virtual contact members, and communication data 204 comprises items of contact member names, virtual communication data and the virtual group that a member belongs to. The physical communication database 206 comprises communication data 208 of physical contact members, and communication data 208 comprises items of contact member names, physical communication data and the physical group that a member belongs to. The communication database 200 also comprises both virtual and physical trust degree information 210, which is the basis of the trust mechanism of the communication database 200. The data calculation of the virtual and physical trust degree information 210 determines how the communication proceeds or how to share the data.

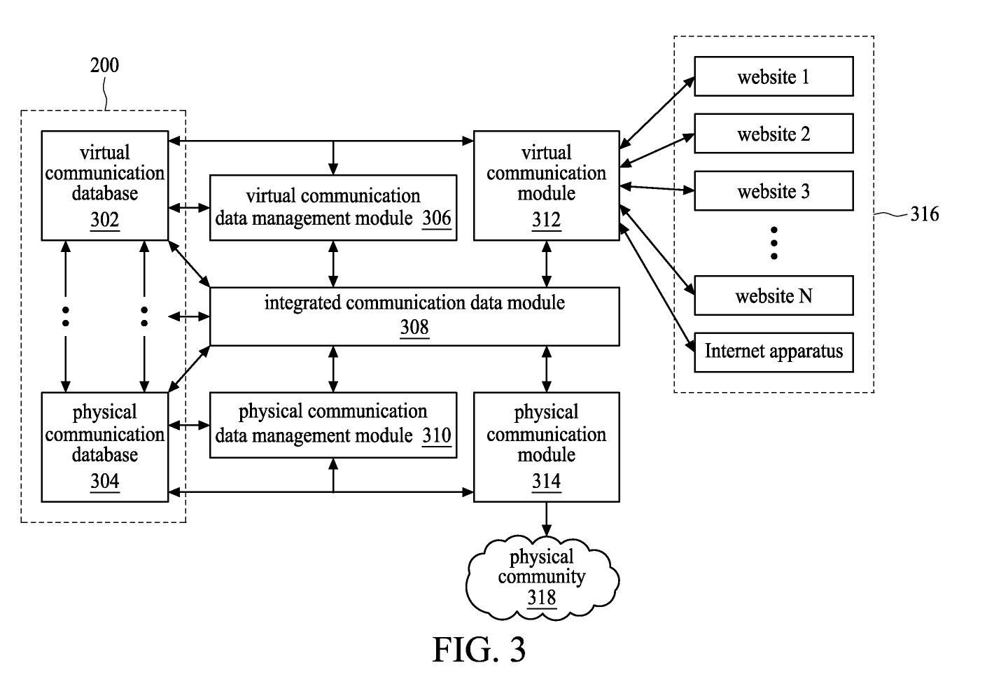

Referring to FIG. 3, a virtual communication database 302 is established, updated and managed by a virtual communication data management module 306, while a physical communication database 304 is established, updated and managed by the physical communication data management module 310. The integration of data between the virtual communication database 302 and the physical communication database 304 is performed by an integrated communication data module 308 to proceed to an operation for establishing, updating and managing the corresponding related data. A virtual communication module 312 provides, according to a communication request, a proxy access service, a communication redirection service and communication services between websites of a virtual community 316 and Internet apparatuses via a virtual communication database 302. A physical communication module 314 provides, according to a communication request, a proxy access service, a communication redirection service and communication services to a physical community 318 via a physical communication database 304. The integrated communication data module 308 communicates with a physical community 318, according to a communication request, using a proxy access service, a communication redirection service and communication services, and information in the physical communication database 304 and the virtual communication database 302. The integrated communication data module 308 also comprises data requirements, access and transformation between the virtual communication module 312 and the physical communication module 314, so that the virtual community 316 and the physical community 318 can share and interchange data directly.

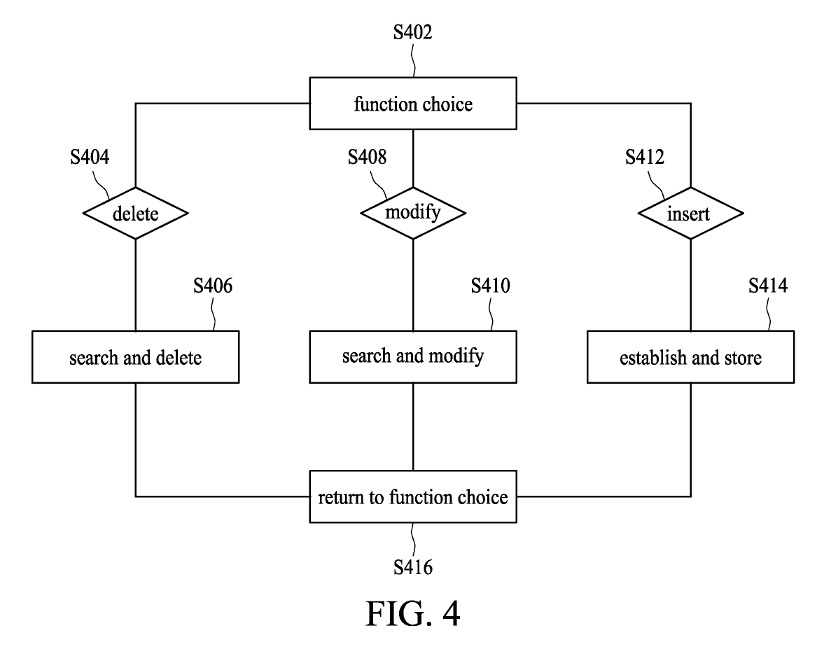

Referring to FIG. 3 and FIG. 4, an embodiment illustrates a flow diagram that describes steps in a communication data management including the virtual communication data management module 306, the integrated communication data module 308, and a physical communication data management module 310. The function choice of the communication data management (step S402) comprises deleting (step S404), modifying (step S408), and inserting (step S412). When a user chooses step S404, a system calls the corresponding module (the virtual communication data management module 306, the integrated communication data module 308, or the physical communication data management module 310) based on the property (physical, virtual, or both) of the contact member, and the module searches the contact member in the corresponding database (the virtual communication database 302 or the physical communication database 304), deletes the contact member (step S406), and then returns to the function choice step (step S416). When a user chooses step S408, a system calls the corresponding module (the virtual communication data management module 306, the integrated communication data module 308, or the physical communication data management module 310) based on the property (physical, virtual, or both) of the contact member, and the module searches the contact member in the corresponding database to provide users for modifying (step S410), and then returns to the function choice step (step S416). When a user chooses step S412, a system calls the corresponding module (the virtual communication data management module 306, the integrated communication data module 308, or the physical communication data management module 310) based on the property (physical, virtual, or both) of the contact member, so that users may establish or import the data through the module and the data is saved in the corresponding database (step S414). Then, it returns to the function choice step (step S416).

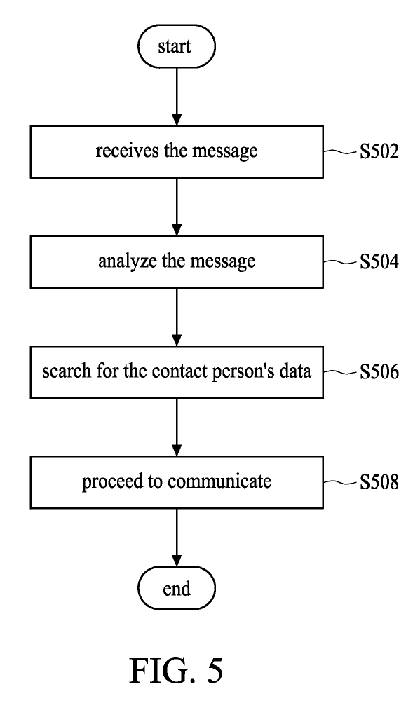

Referring to FIG. 3 and FIG. 5, an embodiment illustrates a flow diagram including the integrated communication data module 308, a physical communication data management module 310, and the virtual communication module 312. After receiving the inputted message by users or community members from a networked virtual reality or a physical environment, the system analyzes the message to determine whether the message communication object comes from a networked virtual reality or a physical environment. Then, the message is sent to the corresponding module (the integrated communication data module 308, a physical communication module 314, and the virtual communication module 312). In step S502, the module receives the message transmitted from the apparatus. In step S504, the message is analyzed to retrieve the contact member of the message. In step S506, the module searches the contact members and the related communication data according to the trust mechanism from the corresponding database (the virtual communication database 302 or the physical communication database 304). In step S508, the module communicates with related members according to the communication data. The virtual communication module 312 is responsible for processing the message when contact members are virtual objects, while the physical communication module 314 is responsible for processing the message when contact members are physical objects. If contact members include virtual and physical objects, the integrated communication data module 308 is responsible for proceeding to the integrated communication work.

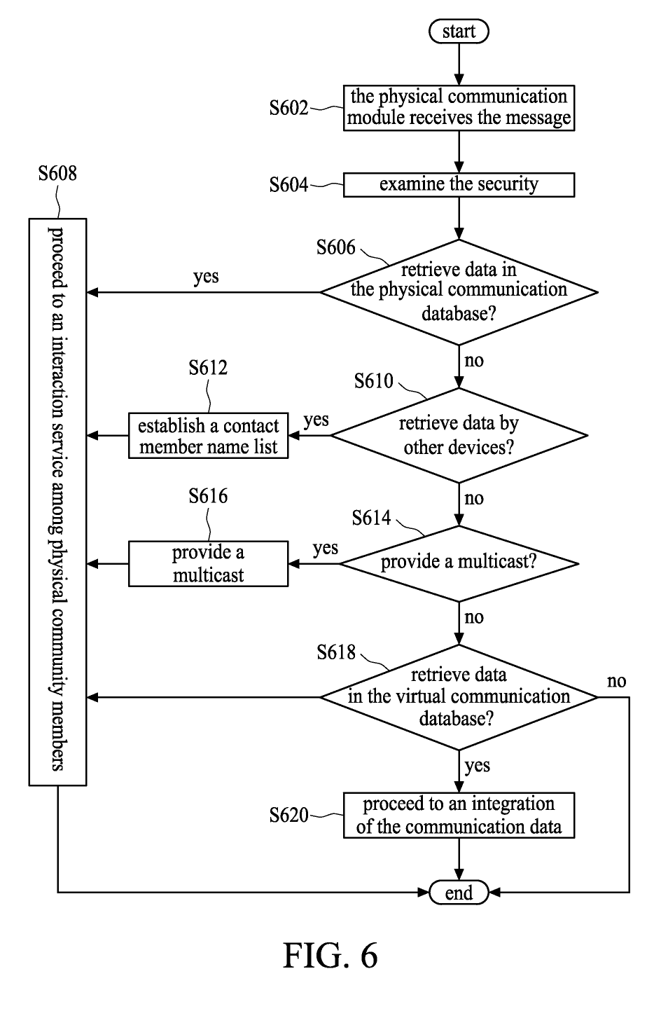

Referring to FIG. 6, in step S602, the physical communication module receives the message inputted by users or transmitted by the community members in a physical environment. In step 604, the physical communication module performs a security check, which is a well-known protection or a management mechanism for network online security. In decision S606, the physical communication module determines whether the object of the message is from the contact members of the physical communication database. If the answer to the decision 606 is yes, then the acquirement of the contact member information is provided by the physical database. The physical communication module may examine in advance whether community members who send the message match the trust mechanism or not, before the allowance of the information requirement. The examination of the trust mechanism is to retrieve what is a core community descriptive element that the message comprises, and then to extract the corresponding personal social network from the trusty network according to the core community descriptive element, and finally to examine whether the community member belongs to the personal social network. After the physical communication data is retrieved, the physical communication module continues to proceed to an interaction service of physical community members in step S608. In step S610, the message is a community member information acquirement by other devices. In similar manner, the physical communication module may examine with the trust mechanism before the allowance of the information acquirement. In step S612, a contact member name list is established based on the trust information between community members, and the trust information comprises the relationship and the trust degree between members. The list determines whether the service of the community member information acquirement for other devices in the interaction service of physical community members as shown in step S608 can be proceeded or not. In decision S614, a multicast request is determined. If the answer to the decision 614 is yes, then the multicast transport service is provided to an interaction service of physical community members (step S616 and step S608). In step S618, the physical communication module determines whether the message is sent to the member in the virtual communication database. In step S620, if the sent message comprises members in virtual communication database, then the integrated communication data module transmits the message or the service that the message requires to all members after searching all the physical and virtual members.

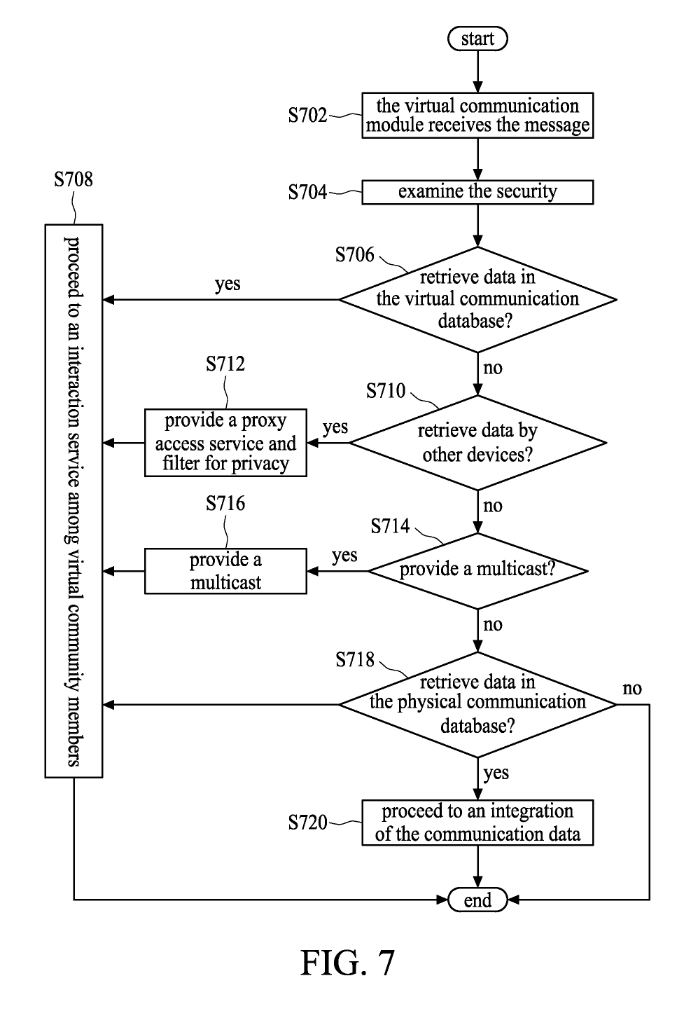

Referring to FIG. 7, in step S702, the virtual communication module receives the message transmitted by users or community members in a virtual environment. In step 704, the virtual communication module performs a security check, which is a well-known protection or a management mechanism for network online security. In decision S706, the virtual communication module determines whether the object of the message is from the contact members of the virtual communication database. If the answer to the decision 706 is yes, then the acquirement of the contact member information is provided by the virtual database. The virtual communication module may examine in advance whether community members who send the message match the trust mechanism or not, before the allowance of the information requirement. The examination of the trust mechanism is to retrieve what is a core community descriptive element that the message comprises, and then to extract the corresponding personal social network from the trusty network according to the core community descriptive element, and finally to examine whether the community member belongs to the personal social network. After the virtual communication data is retrieved, the virtual communication module continues to proceed to an interaction service of virtual community members in step S708. In step S710, the message is a community member information acquirement for other devices. In similar manner, the virtual communication module may examine the trust mechanism before the allowance of the information acquirement. In step S712, if the message is the community member information acquirement by other devices, the virtual communication module searches the virtual contact member matching the trust mechanism that the present invention discloses for privacy filter. In decision S714, a multicast request is determined. If the answer to the decision 714 is yes, then the multicast transport service is provided to an interaction service of virtual community members (step S716 and step S708). In step S718, the virtual communication module determines whether the message is sent to the member in the physical communication database. In step S720, if the sent message comprises members in physical communication database, then the integrated communication data module transmits the message or the service that the message requires to all members after searching all the physical and virtual members.

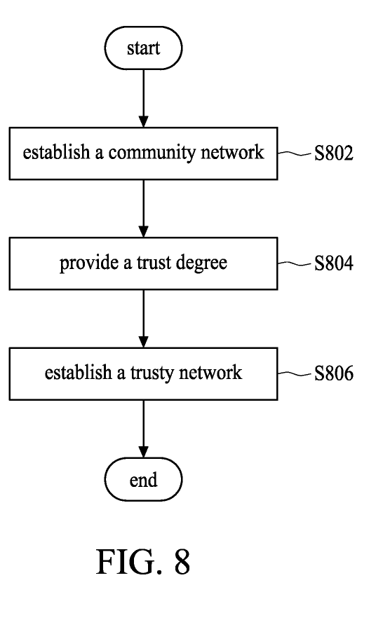

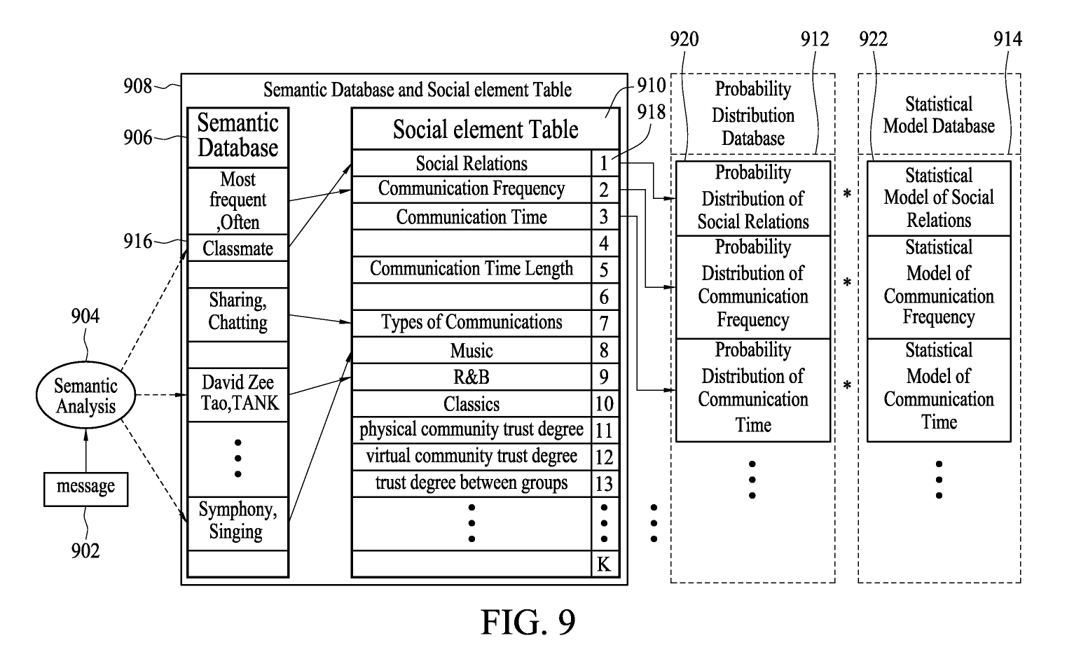

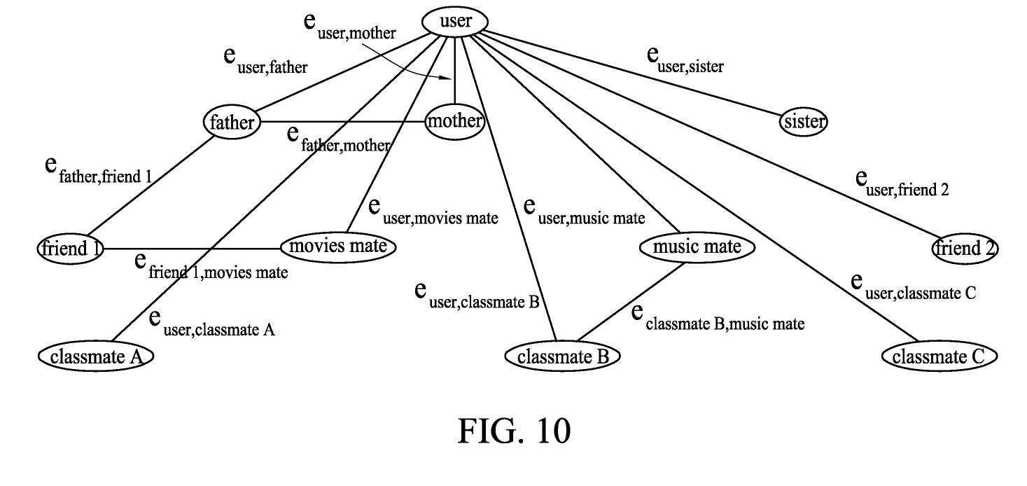

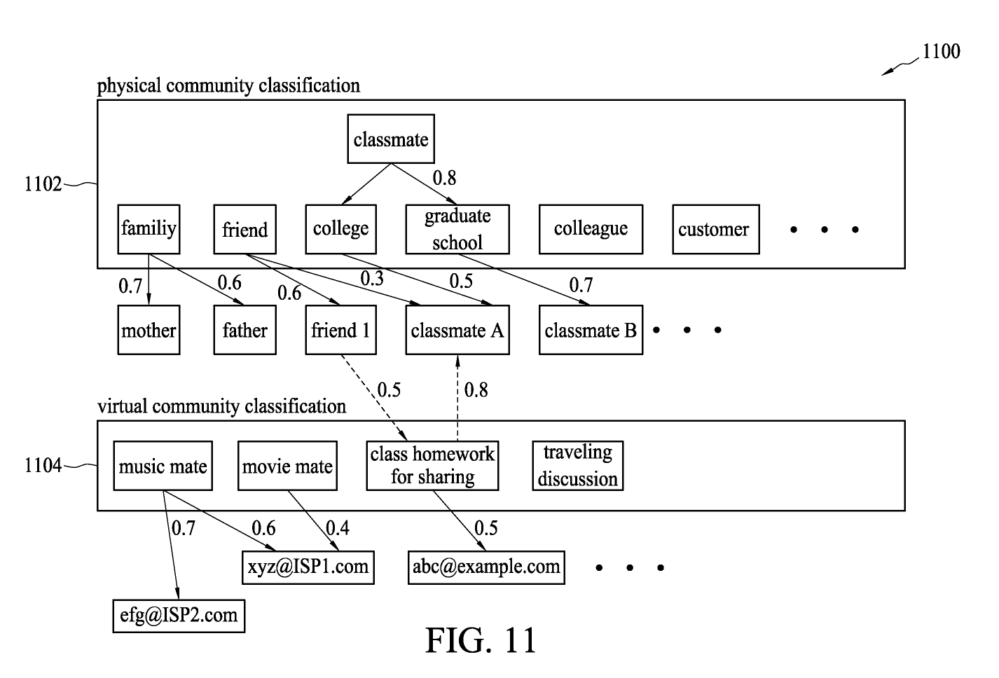

Referring to FIG. 8, FIG. 9, FIG. 10, and FIG. 11, in step S802, related terms of groups and/or related terms of sub-groups are established in a semantic database, so that a message 902 is analyzed or a core community descriptive element is provided; the system may search the related terms of groups and/or related terms of sub-groups in the semantic database for sorting the members and establishing a community network. As shown in FIG. 9, “classmate” 916 is the related term of groups, which is set up in a semantic database 906. The community network comprises physical and virtual members forming the network as shown in FIG. 10. The relationship between contact members i and j is represented as e_{i, j}. As shown in FIG. 10, the relationship between the user and his father is shown as e_{user, father}. The strength of the relationship is represented as a relation vector Value(e_{i,j}). For example, the relation vector between the user and his father is represented as Value(e_{user, father}). The elements of Value(e_{user, father}) comprise a physical community trust degree, a virtual community trust degree, a trust degree between groups, a value of the communicating frequency, the average time of the communication, the longest communication time, the ratio of the common interest and a favorite degree.

Referring to FIG. 9, a message 902 is analyzed by a semantic analysis algorithm 904 for semantic data. The semantic data comprises a related term representative of the frequency, such as most frequent or often, a term representative of the group, such as classmate 916, and a term representative of the activity, such as sharing or chatting. Then, a social element 910 corresponding to the semantic data is corresponding to a semantic database and social element table 910. Social elements include social relations 918, communication frequency, communication time, and so on. The value of the social element 910 can be calculated by multiplying the probability distribution database 912 and the corresponding value stored in a statistical model database 914. In one embodiment, the message 902 is analyzed by the semantic analysis algorithm 904 and the related term “classmate 916” is extracted from the semantic database. Subsequently, the social element “social relations 918” is selected from the social elements 910 corresponding to the semantic database 906. The value of the social relations 918 is calculated by multiplying the probability distribution of social relations 920 and the statistical model of social relations 922. The probability distribution of social relations 920 is a statistic value representative of the communication times over a time interval, and the time interval may be, for example, one day, one to two days, or two to three days. At every time interval, the value of probability distribution is normalized over the total number of communication links. The statistical model of social relations 922 is selected from statistic models suitable for the current data distribution type. Through the flow diagram mentioned above, a related value between the contact member and the message 902 is calculated with the social elements 910 according to the message 902, and then a candidate for contact members is selected based on the related value.

The values of the social elements 910 are calculated as statistics with an instant property, and thus they are used to update values of the relation vectors between contact members.

Referring to FIG. 8, in step S804, the corresponding value of the trust degree is provided to the relation vector between the groups in the community network or between the groups and the members who belong to the groups. In step S806, the community network is transferred to a trusty network after the values of the trust degree are set up, as shown in FIG. 11.

Referring to FIG. 11, a trusty network 1100 is a multi-layer hierarchy architecture used in physical and virtual communication environments of the present invention. The multi-layer hierarchy architecture relies on a user behavior or a substantial relationship to sort the groups of different properties based on a user set point or a calculation result of a social relation analysis algorithm. The multi-layer hierarchy architecture comprises a physical community classification 1102 and a virtual community classification 1104. The physical community classification 1102 comprises friends and classmates or a classification based on user's social relations, such as family, and groups in the physical community classification 1102 comprise contact members in the physical environment, while the virtual community classification 1104 comprises a movie mate or a classification based on a behavior or an activity, such as a class homework for sharing, and groups in the virtual community classification 1104 comprise contact members in the virtual environment.

The value of the trust degree mentioned above represents the level of the trust degree between the classification and the members who belong to the classification, or between the groups and the sub-groups. The trust degree comprises a physical community trust degree, a virtual community trust degree, and a trust degree between groups. The higher the trust degree, the lower the risk of the information sharing. The trust degree is transferred to a normalized value based on the calculation set up by a system, and the normalized value is in the range from 0 to 1. The setup of the trust degree between different levels maintains coincidence, and the trust degree of the upper layer is higher than the maximum value of the trust degree of the lower layer. For example, the weighting value between a classmate and a graduate school, a lower level of the classmate, in the physical social group classification 1102 is 0.8, while the weighting value between the graduate school and a classmate B is 0.7, lower than 0.8.

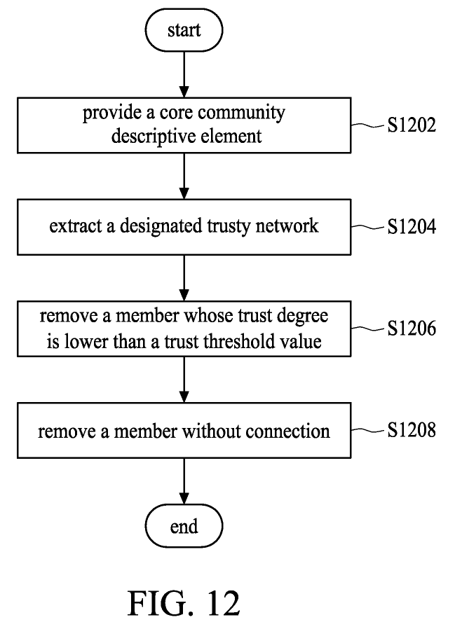

Referring to FIG. 12, in step S1202, a user may directly provide a core community descriptive element required for establishing a personal social network, or the core community descriptive element may be analyzed from a received message. The analysis comprises a semantic analysis algorithm. The core community descriptive element comprises a group related term, a target behavior, and a trust threshold value. The group comprises a family, and a group set has a number of related groups, such as friends and a class homework for sharing. The target behavior comprises direct data exchanging, indirect data exchanging, and indirect communication. The threshold value of the trust degree can be determined by users, and the threshold value of the trust degree is not lower than a predetermined value. In step S1204, a designated trusty network is extracted from the trusty network based on the core community descriptive element. The designated trusty network is a network related to the target behaviors. If the target behaviors are larger than an item and have the independence, the sets formed by each independent target behavior generate the related networks based on the target behaviors. In step S1206, remove the members whose trust degrees are lower than the corresponding trust threshold value between the members of the designated trusty network. In step S1208, remove members without direct or indirect connection from the rest of the members in the designated trusty network.

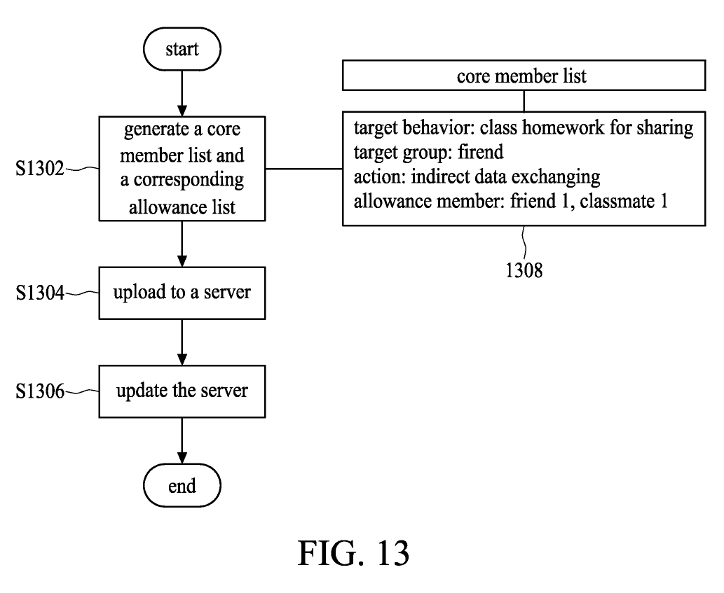

Referring to FIG. 13, a server has a corresponding allowance list, used to filter the objects to which data is transferred, and thus ensures the security of the transfer data or rejects the unnecessary data. After receiving the message, the server analyzes the message for the core community descriptive element, searches the corresponding allowance list based on the core community descriptive element, and then examines the objects to which data is transferred. A flow diagram for generating a corresponding allowance list is described below. In step S1302, a core member list and a corresponding allowance list are generated in an apparatus. The corresponding allowance list 1308 comprises members and the corresponding target behaviors, and the content in the corresponding allowance list 1308 includes target behaviors, target groups, actions and allowance members. The target behaviors may comprise a class homework for sharing in this embodiment; the target groups comprise a friend; the actions comprise a manner implemented by the target groups, such as indirect data exchanging; and target behaviors comprise members matching the trust mechanism. In step S1304, the core member list and the corresponding allowance list are uploaded to the server, so that the shared message can be filtered in the server and users with low trust degree may not receive the message. In step S1306, the server is updated after receiving the core member list and the corresponding allowance list 1308. The server can receive all data uploaded by community users, and thus the database of the server comprises the data list of the contact members who upload the data in the community network, and the corresponding allowance list 1308 corresponding to the data list.

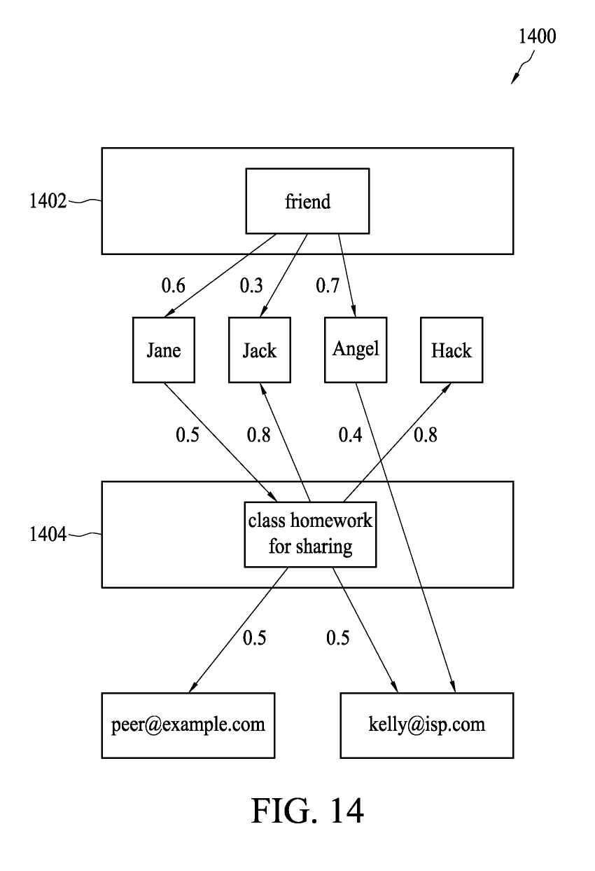

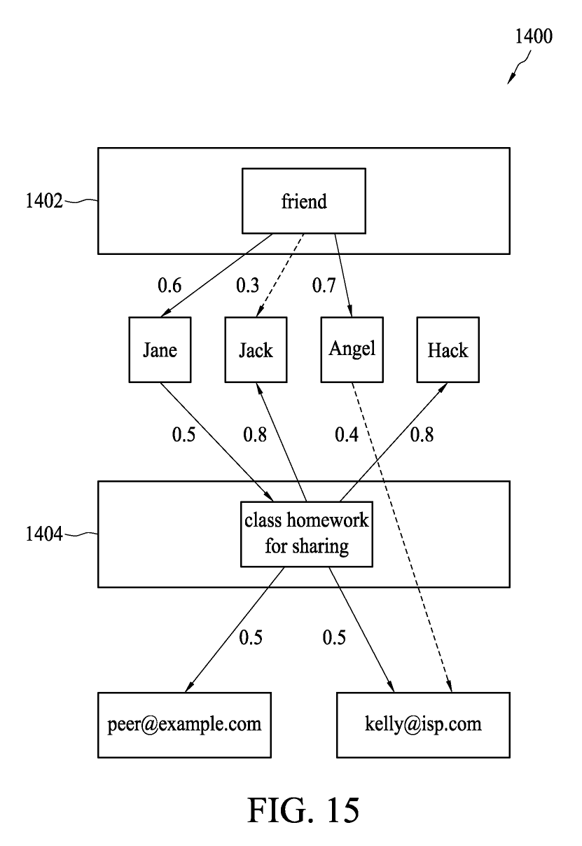

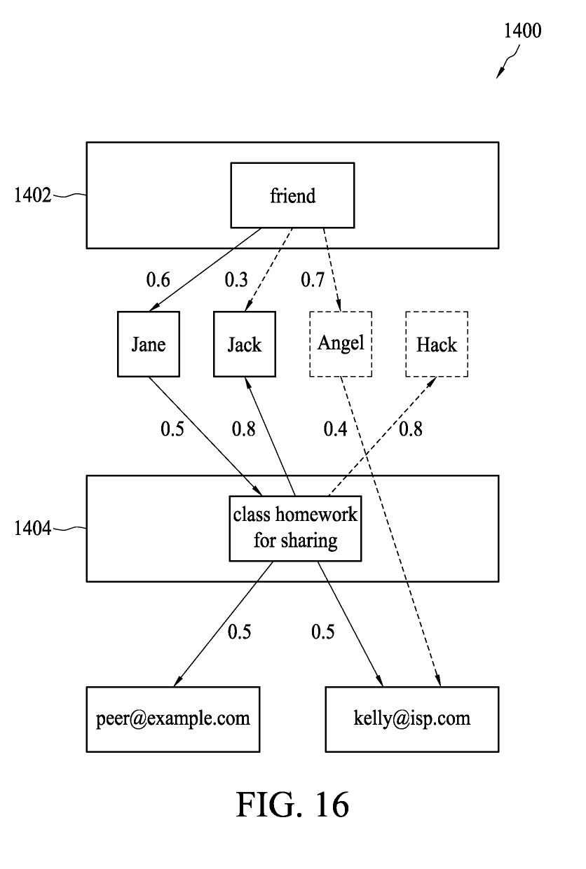

Referring to FIG. 14-16, users want to share a class homework assignment, and thus they input core community descriptive elements comprising groups: {friend, a class homework for sharing}, target behaviors {indirect data exchanging→a class homework for sharing} and a trust degree threshold value {0.45}. The apparatus extracts the designated trusty network 1400 according to the group of the core community descriptive elements. The designated trusty network 1400 comprises two groups: one is “friend” who belongs to the physical community classification 1402 and the other is “class homework for sharing” which belongs to the virtual community classification 1404. The group “friend” includes members, such as Jane, Jack and Angel, and the group “class homework for sharing” includes members, such as Hack in the physical community environment, peer@example.com and Kelly@isp.com in the virtual community environment. In addition, Angel and Kelly@isp.com have a connection in this embodiment. After the removable process based on the trust threshold value, the connections of Jack and Angel in the group “friend,” and Kelly@isp.com in the group “class homework for sharing” are removed because their trusted values are lower than the threshold value. The removable connections are shown in dotted lines in FIG. 15. Then, during the process of removing members without connections, because Angel and Hack both have no connections with the group “friend” and the group “class homework sharing,” they are regarded as members with no direct or indirect connection, and thus both are removed from the objects of the class homework for sharing as shown in FIG. 16.

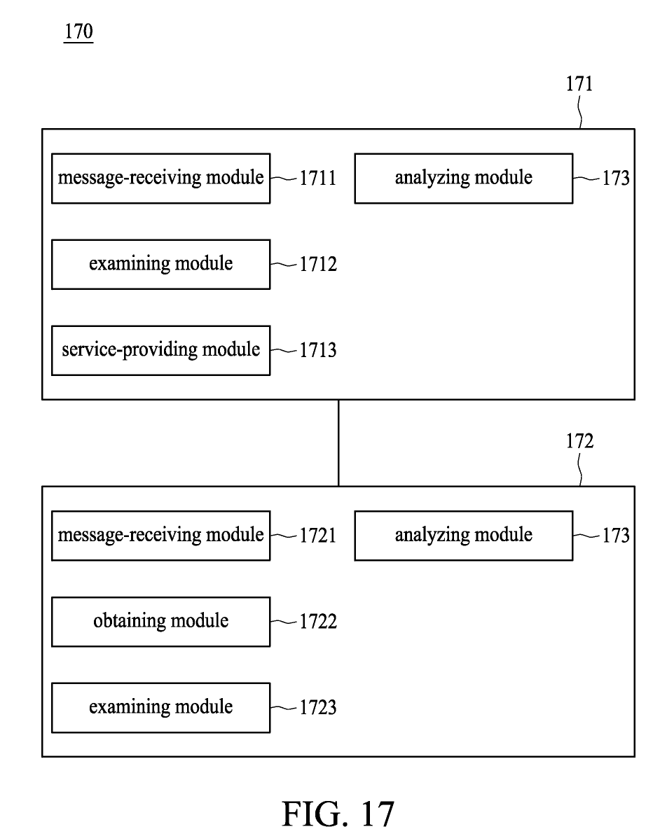

The present invention discloses a community networking system as shown in FIG. 17, the community networking system 170 comprises a personal apparatus 171 connected to the Internet. The personal apparatus 171 comprises a message-receiving module 1711 for receiving a message from a member of a first environment, an examining module 1712 for examining whether the member of the first environment belongs to a first personal social network according to a community descriptive element of the message, and a service-providing module 1713 for providing a service according to the acquirement of the message if the member of the first environment belongs to the first personal social network. The community networking system 170 also comprises a server 172 comprising a message-receiving module 1721 for receiving the message from the apparatus 171 and obtaining a core community descriptive element from the message, a obtaining module 1722 for obtaining an allowance corresponding list corresponding to the core community descriptive element from a storage apparatus, and an examining module 1723 for examining whether the apparatus 171 and/or members belonging to the apparatus 171 are in the allowance corresponding list. The personal apparatus 171 and the server 172 further comprise an analyzing module 173 for analyzing the community descriptive element and the core community descriptive element by a semantic analysis algorithm 904.

The architecture has advantages as shown below. The personal information apparatus and the server as a service provider have independence and complementarity, and are easy to rebuild; users can use the same apparatus in different service providers, without providing a user profile for a specific service provider, and users can be easily transferred to another information service provider. Users can build core information on a personal community with different properties in the same or different apparatus, and thus the dynamic adaptability is strong.

The above-described embodiments of the present invention are intended to be illustrative only. Numerous alternative embodiments may be devised by persons skilled in the art without departing from the scope of the following claims.

What is claimed is:

1. A method for establishing a personal social network, comprising the steps of:
providing a plurality of core community descriptive elements;
extracting a designated trusty network from a trusty network according to the core community descriptive elements;
removing a member in the designated trusty network whose trust degree is lower than a trust threshold value; and
removing a member without connection in the designated trusty network according to the core community descriptive elements.

2. The method of claim 1, further comprising the step of:
providing a message; and
analyzing the core community descriptive elements of the message.

3. The method of claim 2, wherein the analyzing step further comprises analyzing the message by a semantic analysis algorithm.

4. The method of claim 3, wherein the core community descriptive elements comprises group related terms, a target behavior, and a trust threshold value.

5. The method of claim 1, further comprising the step of establishing a core member list and a corresponding allowance list.

6. The method of claim 1, wherein a value of a trust degree in a first layer is higher than a value of a trust degree in a sub-layer of the first layer.

7. The method of claim 1, further comprising the step of setting the trust threshold value of the group of the trusty network as not lower than a predetermined value.

8. A method for establishing a trusty network, comprising the steps of:
setting a group related term;
establishing a community network according to the group related term; and
setting a trust degree between a group of the community network and a member of the group.

9. The method of claim 8, further comprising the step of setting the group related term in a semantic database.

10. The method of claim 8, wherein the group related term is a group related term and/or a sub-group related term.

11. The method of claim 8, further comprising the steps of calculating the trust degree between contact members according to a plurality of social elements, and calculating related values according to the social elements.

12. The method of claim 11, wherein the plurality of social elements comprises a physical community trust degree, a trust degree of a virtual community, and trust degrees between groups.

13. The method of claim 11, wherein the calculating method of the social elements comprises performing multiplication of a probability distribution of the social element and a statistical model of the social element.

14. The method of claim 11, wherein the probability distribution of the social elements is a statistic value of communication times over a time interval.

15. A communication method of a community system, comprising the steps of:
receiving a message from a member of a first environment by an apparatus;
examining whether the member of the first environment belongs to a first personal social network corresponding to the message according to a community descriptive element of the message; and
providing a service according to the acquirement of the message if affirmative.

16. The method of claim 15, further comprising the steps of:
examining whether the member of the first environment belongs to a second personal social network corresponding to the message according to the community descriptive element of the message; and
providing a service according to the acquirement of the message if affirmative.

17. The method of claim 15, further comprising:
obtaining a core community descriptive element from the message by a server;
obtaining an allowance corresponding list corresponding to the core community descriptive element by the server; and
examining whether the apparatus and/or members belonging to the apparatus are in the allowance corresponding list.

18. The method of claim 15, wherein the apparatus comprises a trusty network, and the trusty network comprises the first personal social network and the second personal social network.

19. The method of claim 18, wherein the trusty network is managed by a multi-layer hierarchy architecture.

20. The method of claim 18, wherein the service provides member contact information acquirement, community member contact information acquirement for other devices, and multicast.

21. A community networking system comprising:
a personal apparatus connected to the internet, the personal apparatus comprising a message-receiving module for receiving a message from a member of a first environment, an examining module for examining whether the member of the first environment belongs to a first personal social network according to a community descriptive element of the message, and a service-providing module for providing a service according to the acquirement of the message if the member of the first environment belongs to the first personal social network; and
a server comprising a message-receiving module for receiving the message from the apparatus and obtaining a core community descriptive element from the message, an obtaining module for obtaining an allowance corresponding list corresponding to the core community descriptive element from a storage apparatus, and an examining module for examining whether the apparatus and/or members belonging to the apparatus are in the allowance corresponding list.

22. The system of claim 21, wherein the personal apparatus and the server further comprise an analyzing module for analyzing the community descriptive element and the core community descriptive element by a semantic analysis algorithm.
